(19) United States
(12) Patent Application Publication
(10) Pub. No.: US 2016/0165500 A1
(43) Pub. Date: Jun. 9, 2016

(54) BASE STATION AND COMMUNICATION CONTROL METHOD

(71) Applicant: FUJITSU LIMITED, Kawasaki-shi (JP)

(72) Inventor: Tetsuya Hasegawa, Fukuoka (JP)

(73) Assignee: FUJITSU LIMITED, Kawasaki-shi (JP)

(21) Appl. No.: 14/926,032

(22) Filed: Oct. 29, 2015

(30) Foreign Application Priority Data
Dec. 8, 2014 (JP) 2014-248432

(51) Int. Cl. H04W 36/04; H04W 36/30; H04W 16/32

(52) U.S. Cl. CPC H04W 36/04; H04W 16/32; H04W 36/30

(57) ABSTRACT

A base station that forms a second cell that overlaps with a first cell formed by a different base station includes a determining unit that determines a state of implementation of inter-cell interference coordination that is performed between the first cell and the second cell by the different base station, and a control unit that estimates an offset value set by the different base station for a downlink reception power value of the second cell, based on first reception power of the second cell in a user terminal at the time of non-implementation of the inter-cell interference coordination and based on second reception power of the second cell in the user terminal at the time of implementation of the inter-cell interference coordination, and adjusts the downlink reception power value in the user terminal based on the estimated offset value.

### CROSS-REFERENCE TO RELATED APPLICATION

This application is based upon and claims the benefit of priority of the prior Japanese Patent Application No. 2014-248432, filed on Dec. 8, 2014, the entire contents of which are incorporated herein by reference.

### FIELD

The embodiments discussed herein are related to a base station and a communication control method.

### BACKGROUND

Conventionally, various efforts have been made to increase a transmission capacity of a communication system, that is, a system capacity, in order to prevent a reduction in the throughput of a user terminal (user equipment: UE). For example, in the 3rd Generation Partnership Project Long Term Evolution (3GPP LTE), a communication system called a heterogeneous network (HetNet) has been studied. In the HetNet, a “picocell” or a “femtocell” that is a base station with small downlink transmission power and a small communication area is deployed as an overlay on a “macrocell” that is a base station with large downlink transmission power and a large communication area. The picocell and the femtocell have smaller communication areas than that of the macrocell; therefore, they are collectively referred to as a “small cell” in some cases. In the following, a base station that forms a macrocell may be referred to as a “macrocell base station” or an “MC (macrocell) base station”. Further, a base station that forms a small cell may be referred to as a “small cell base station” or an “SC (small cell) base station”.

In the HetNet, a connection destination of a user terminal is handed over from a macrocell that does not have enough capacity to a small cell to offload traffic from the macrocell to the small cell in order to increase the system capacity. However, in the HetNet, the downlink transmission power of the SC base station is smaller than the downlink transmission power of the MC base station as described above. Therefore, in a user terminal located at the cell edge of the small cell, downlink reception power of the small cell is reduced due to radio wave interference from the macrocell. Namely, the communication area of the small cell is substantially reduced due to the radio wave interference from the macrocell. Consequently, a handover from the macrocell to the small cell is less likely to occur.

Therefore, in the 3GPP LTE, a study has been made to implement range expansion called “cell range expansion (CRE)” of the small cell in order to accelerate a handover from the macrocell to the small cell. In the CRE, an “offset value” is given to a downlink reception power value of the small cell to expand the range of the small cell in a pseudo manner. When the CRE is implemented, a connection destination cell of the user terminal is selected based on a result of comparison of the sum of the offset value and the downlink reception power value of the small cell with the downlink reception power value of the macrocell. Therefore, by implementing the CRE, a handover from the macrocell to the small cell is accelerated. However, radio wave interference from the macrocell is large at the cell edge of the small cell, and the communication quality of the user terminal located at the cell edge of the small cell is reduced. Incidentally, the offset value given to the downlink reception power value when the CRE is implemented may be referred to as a “CRE offset value” or a “CRE bias value”.

Therefore, in the 3GPP LTE, a study has been made to introduce “inter-cell interference control” called “enhanced inter-cell interference coordination (eICIC)” into the HetNet in order to reduce radio wave interference from the macrocell to the small cell. The inter-cell interference control may be referred to as “inter-cell interference coordination (ICIC)” or “further-enhanced inter-cell interference coordination (FeICIC)”. In the eICIC, transmission of a data signal is stopped or a data signal is transmitted with lower power than normal in some of subframes transmitted from the MC base station, in order to reduce radio wave interference from the macrocell to the small cell. A subframe, in which transmission of the data signal is stopped or the power of the data signal is reduced, may be referred to as an “almost blank subframe (ABS)”. By assigning a communication resource during the ABS of the MC base station to the user terminal located at the cell edge of the small cell, the user terminal located at the cell edge of the small cell can receive a data signal without being subjected to radio wave interference from the macrocell during the ABS. Therefore, by introducing the eICIC into the HetNet, it is possible to improve the communication quality of the user terminal located at the cell edge of the small cell.

In this manner, in the HetNet, the CRE and the eICIC are used in combination. That is, in the HetNet, in general, the eICIC is implemented with the implementation of the CRE. Therefore, it is possible to determine that the CRE is not implemented when the eICIC is not implemented.

Examples of related-art are described in Japanese Laid-open Patent Publication No. 2013-038585, in Japanese Laid-open Patent Publication No. 2012-222633, in International Publication Pamphlet No. 2011/126024, and in 3GPP TS36.300 V12.2.0 16.1.5

The CRE offset value is provided to the user terminal from a base station to which the user terminal is connected. Specifically, when the user terminal performs a handover from a macrocell to a small cell for example, the MC base station provides the CRE offset value to the user terminal before the handover and the SC base station provides the CRE offset value to the user terminal after the handover.

Incidentally, in the current 3GPP LTE specifications, a message for exchanging the CRE offset value between base stations (for example, between an MC base station and an SC base station) is not defined. Therefore, for example, it is difficult to directly provide the CRE offset value set by the MC base station to the SC base station. Namely, according to the current 3GPP LTE specifications, the CRE offset value set by the MC base station is not taken over by other base stations (for example, the SC base station), and therefore, it is difficult to share the same CRE offset value between the base stations (for example, the MC base station and the SC base station). Therefore, after the user terminal performs a handover from a macrocell to a different cell (for example, a small cell), the CRE offset value set before the handover is lost, and the range of the cell (for example, the small cell) is not expanded by the CRE offset value. Consequently, because the CRE offset value before the handover is lost, the user terminal that has performed the handover from the macrocell to the different cell (for example, the small cell) by the CRE may perform a handover again to the same macrocell as before the handover, immediately after the handover. If the handover is frequently performed as described above, the throughput of the user terminal is reduced.

### SUMMARY

According to an aspect of an embodiment, a base station that forms a second cell that overlaps with a first cell formed by a different base station includes a determining unit that determines a state of implementation of inter-cell interference coordination that is performed between the first cell and the second cell by the different base station, and a control unit that estimates an offset value set by the different base station for a downlink reception power value of the second cell, based on first reception power of the second cell in a user terminal at the time of non-implementation of the inter-cell interference coordination and based on second reception power of the second cell in the user terminal at the time of implementation of the inter-cell interference coordination, and adjusts the downlink reception power value in the user terminal based on the estimated offset value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a communication system of a first embodiment;

FIG. 2 is a functional block diagram illustrating an example of a configuration of a small cell base station of the first embodiment;

FIG. 3 is a diagram illustrating an example of an eICIC state table of the first embodiment;

FIG. 4 is a diagram illustrating an example of the flow of a process performed by the communication system of the first embodiment;

FIG. 5 is a diagram illustrating an example of the flow of a process performed by the communication system of the first embodiment;

FIG. 6 is a diagram illustrating an example of the flow of a process performed by the communication system of the first embodiment;

FIG. 7 is a diagram illustrating an example of a reception power value table of the first embodiment;

FIG. 8 is a diagram illustrating an example of an offset estimated value calculation table of the first embodiment;

FIG. 9 is a diagram illustrating an example of an offset estimated value calculation method of the first embodiment;

FIG. 10 is a diagram illustrating an example of an offset estimated value table of the first embodiment;

FIG. 11 is a diagram illustrating an example of the flow of a process performed by the communication system of the first embodiment;

FIG. 12 is a diagram illustrating an example of an offset setting value table of the first embodiment;

FIG. 13 is a diagram illustrating an example of the offset setting value table of the first embodiment;

FIG. 14 is a diagram illustrating an example of the offset setting value table of the first embodiment;

FIG. 15 is a diagram illustrating an example of the offset setting value table of the first embodiment;

FIG. 16 is a diagram illustrating an example of a reception power value table of a second embodiment;

FIG. 17 is a diagram illustrating an example of an offset estimated value calculation table of the second embodiment;

FIG. 18 is a diagram illustrating an example of an offset estimated value table of the second embodiment;

FIG. 19 is a diagram illustrating an example of an offset setting value table of the second embodiment;

FIG. 20 is a diagram illustrating an example of a reception power value table of a third embodiment;

FIG. 21 is a diagram illustrating an example of an offset estimated value calculation table of the third embodiment;

FIG. 22 is a diagram illustrating an example of an offset estimated value table of the third embodiment;

FIG. 23 is a diagram illustrating an example of an offset setting value table of the third embodiment;

FIG. 24 is a diagram illustrating an example of an eICIC state table of a fourth embodiment;

FIG. 25 is a diagram illustrating an example of the flow of a process performed by a communication system of the fourth embodiment;

FIG. 26 is a diagram illustrating an example of an offset setting value table of the fourth embodiment; and

FIG. 27 is a diagram illustrating a hardware configuration example of the small cell base station.

### DESCRIPTION OF EMBODIMENTS

Preferred embodiments of the present invention will be explained with reference to accompanying drawings. A base station and a communication control method disclosed in the present application are not limited to the embodiments. Further, in the embodiments, components with the same functions and steps for the same processes are denoted by the same reference signs, and the same explanation will not be repeated.

### [a] First Embodiment

### Configuration of Communication System

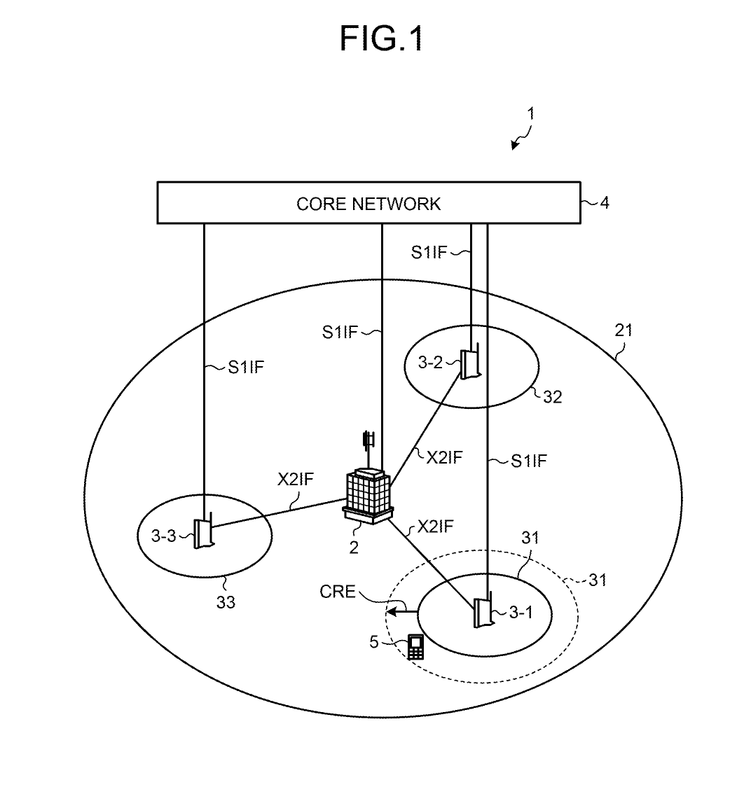

FIG. 1 is a diagram illustrating an example of a configuration of a communication system of a first embodiment. A communication system 1 illustrated in FIG. 1 includes an MC base station 2, SC base stations 3-1 to 3-3, a core network 4, and a user terminal 5. Hereinafter, the SC base stations 3-1 to 3-3 may be collectively referred to as the SC base stations 3 when they need not be distinguished from one another. The MC base station 2 and the SC base stations 3 are connected by S1 interfaces (S1IFs) through the core network 4. Further, the MC base station 2 and the SC base stations 3 are directly connected via X2 interfaces (X2IFs).

The MC base station 2 forms a macrocell 21. In contrast, the SC base station 3-1 forms a small cell 31, the SC base station 3-2 forms a small cell 32, and the SC base station 3-3 forms a small cell 33. That is, in the communication system 1, the small cells 31, 32, and 33 smaller than the macrocell 21 are deployed so as to overlay on the macrocell 21, and the macrocell 21 and the small cells 31, 32, and 33 overlap with one another. That is, the communication system 1 is the HetNet. Hereinafter, the small cells 31, 32, and 33 may be collectively referred to as small cells 30 when they need not be distinguished from one another. In the following, the embodiments of the disclosed technology will be described by using a macrocell and small cells; however, the sizes of the cells are not specifically limited, and the embodiments may be applied to cells of substantially the same size.

In the present embodiment, the small cell 31 will be described as an example of a cell expanded by the CRE. Therefore, the user terminal 5 that is connected to the MC base station 2 and located near the cell edge of the small cell 31 performs a handover from the MC base station 2 to the SC base station 3-1 by the CRE of the small cell 31 in order to change a connection destination base station. Similarly, the other small cells 32 and 33 are also expanded by the CRE.

Configuration of SC Base Station

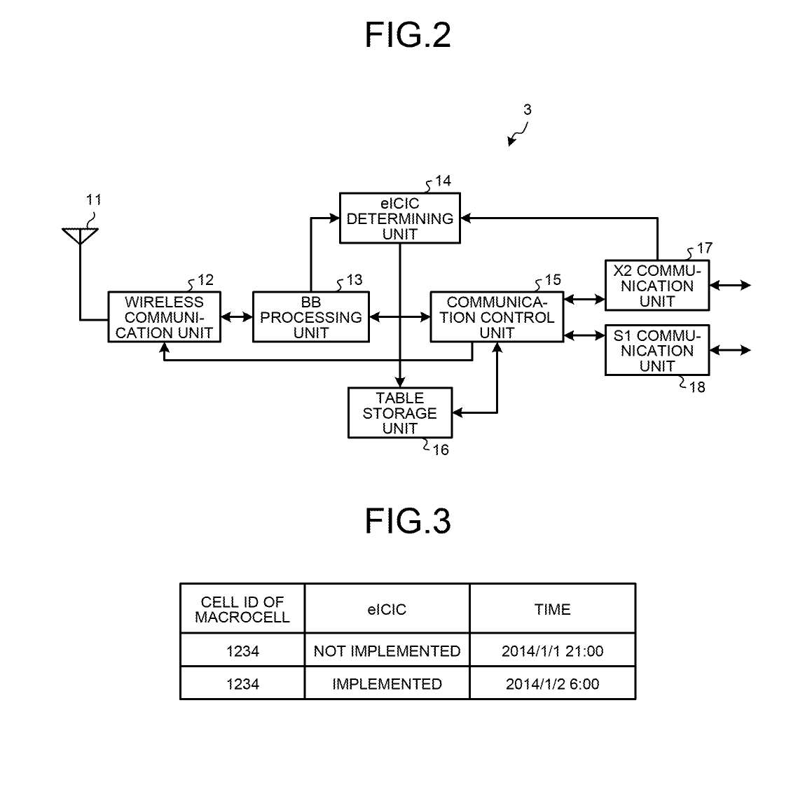

FIG. 2 is a functional block diagram illustrating an example of a configuration of the small cell base station (SC base station) of the first embodiment. In FIG. 2, the SC base station 3 includes an antenna 11, a wireless communication unit 12, a base band (BB) processing unit 13, an eICIC determining unit 14, a communication control unit 15, a table storage unit 16, an X2 communication unit 17, and an S1 communication unit 18.

The wireless communication unit 12 performs a digital-to-analog conversion process, an up-conversion process, and the like on a baseband transmission signal input from the BB processing unit 13, and transmits the transmission signal subjected to the up conversion via the antenna 11. In this case, the wireless communication unit 12 amplifies the power of the transmission signal under the control of the communication control unit 15. Further, the wireless communication unit 12 obtains a baseband reception signal by performing a down-conversion process, an analog-to-digital conversion process, and the like on a reception signal received via the antenna 11, and outputs the baseband reception signal to the BB processing unit 13.

The BB processing unit 13 generates a baseband transmission signal by performing a BB process, such as an encoding process and a modulation process, on transmission data, such as a control message or user data, input from the communication control unit 15, and outputs the generated transmission signal to the wireless communication unit 12. Further, the BB processing unit 13 obtains reception data, such as a control message or user data, by performing a BB process, such as a demodulation process and a decoding process, on the baseband reception signal input from the wireless communication unit 12, and outputs the reception data to the communication control unit 15 and the eICIC determining unit 14.

The X2 communication unit 17 is connected to the MC base station 2 by using the X2 interface. The X2 communication unit 17 transmits a control message input from the communication control unit 15 to the MC base station 2, and outputs a control message received from the MC base station 2 to the communication control unit 15 and the eICIC determining unit 14.

The S1 communication unit 18 is connected to the core network 4 by using the S1 interface. The S1 communication unit 18 transmits, to the core network 4, a control message and user data input from the BB processing unit 13 via the communication control unit 15, and outputs, to the BB processing unit 13, a control message and user data received from the core network 4 via the communication control unit 15.

The table storage unit 16 stores therein various tables.

The eICIC determining unit 14 determines a state of implementation of the eICIC between the macrocell 21 and the small cell 30 by the MC base station 2, that is, whether the MC base station 2 has implemented the eICIC or not (not implemented). The eICIC determining unit 14 updates an “eICIC state table” according to a result of the determination on the state of implementation of the eICIC. The eICIC state table is stored in the table storage unit 16. Determination of the state of implementation of the eICIC will be described in detail later.

The communication control unit 15 generates a control message and outputs the control message to the BB processing unit 13, the X2 communication unit 17, or the S1 communication unit 18. The communication control unit 15 controls communication of the SC base station 3 based on the control message input from the BB processing unit 13, the X2 communication unit 17, or the S1 communication unit 18 and the contents of the table stored in the table storage unit 16. The communication control unit 15 controls transmission power to control the magnitude of amplification of the power of the transmission signal in the wireless communication unit 12.

Process by Small Cell Base Station

In the following, an example will be described in which the SC base station 3 illustrated in FIG. 2 is the SC base station 3-1 illustrated in FIG. 1.

The eICIC determining unit 14 determines whether the MC base station 2 has implemented the eICIC or not (not implemented), and stores a determination result in the eICIC state table. FIG. 3 is a diagram illustrating an example of the eICIC state table of the first embodiment. In FIG. 3, “1234” is a cell ID of the macrocell 21 formed by the MC base station 2. FIG. 3 indicates that the eICIC between the macrocell 21 and the small cell 31 is not implemented on Jan. 1, 2014 at 21:00, but is implemented on Jan. 2, 2014 at 6:00.

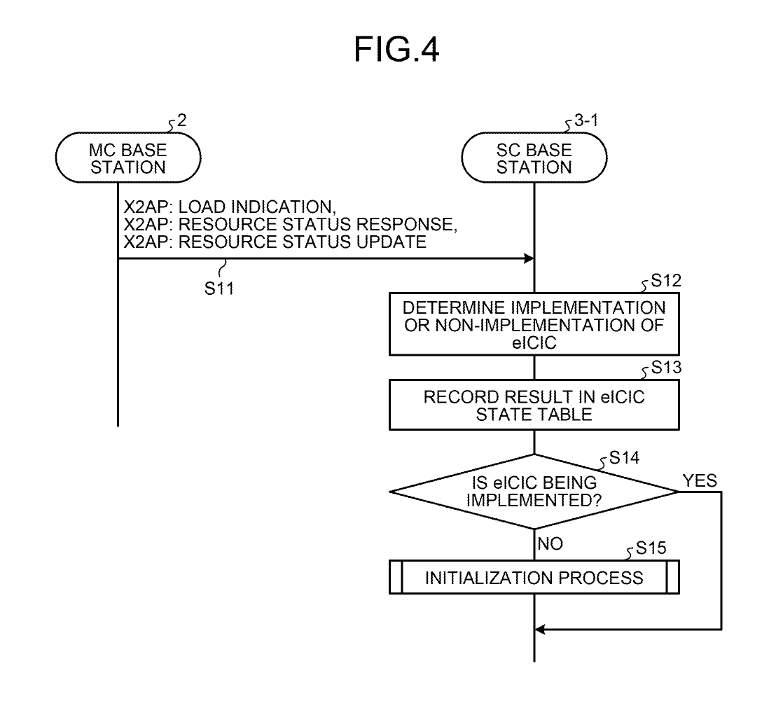

The state of implementation of the eICIC is determined as illustrated in FIG. 4 or FIG. 5. FIG. 4 and FIG. 5 are diagrams illustrating examples of the flow of a process performed by the communication system of the first embodiment. FIG. 4 illustrates determination using an X2AP message. FIG. 5 illustrates determination using notification information.

Example of Determination Using X2AP Message (FIG. 4)

As illustrated in FIG. 4, the MC base station 2 transmits control messages of LOAD INDICATION, RESOURCE STATUS RESPONSE, and RESOURCE STATUS UPDATE to the SC base station 3-1 by using the X2 interface (Step S11). The MC base station 2 notifies the SC base station 3-1 of implementation or non-implementation of eICIC by using the control messages. For example, the control message includes an “eICIC implementation flag”, and the MC base station 2 sets the eICIC implementation flag to “0” when the eICIC is not implemented and sets the eICIC implementation flag to “1” when the eICIC is implemented. Further, the MC base station 2 includes ABS transmission scheduling information in the control message. In the control message, the eICIC implementation flag may be referred to as an ABS status, and the ABS transmission scheduling information may be referred to as ABS information. Furthermore, the control message includes the cell ID of the macrocell 21.

In the SC base station 3-1 that has received LOAD INDICATION, RESOURCE STATUS RESPONSE, and RESOURCE STATUS UPDATE, the eICIC determining unit 14 determines implementation or non-implementation of the eICIC by the MC base station 2 based on the contents of the control messages (Step S12). For example, the eICIC determining unit 14 determines that the eICIC is not implemented when the eICIC implementation flag is “0”, and determines that the eICIC is implemented when the eICIC implementation flag is “1”. For another example, the eICIC determining unit 14 refers to the ABS transmission scheduling information, determines that the eICIC is not implemented when the ABS is not scheduled, and determines that the eICIC is implemented when the ABS is scheduled. Then, the eICIC determining unit 14 stores a result of the determination of implementation or non-implementation of the eICIC in the eICIC state table in association with the cell ID of the macrocell 21 and the reception time of the control messages (Step S13).

The processes at Steps S14 and S15 in FIG. 4 will be described later.

Example of Determination Using Notification Information (FIG. 5)

As illustrated in FIG. 5, the SC base station 3-1 receives notification information wirelessly transmitted from the MC base station 2 (Step S21). The notification information is transmitted by using a physical broadcast channel (PBCH), for example. The notification information includes the ABS transmission scheduling information.

In the SC base station 3-1 that has received the notification information, the eICIC determining unit 14 refers to the ABS transmission scheduling information, determines that the eICIC is not implemented when the ABS is not scheduled, and determines that the eICIC is implemented when the ABS is scheduled (Step S22). Then, the eICIC determining unit 14 stores a result of the determination on implementation or non-implementation of the eICIC in the eICIC state table in association with the cell ID of the macrocell 21 and the reception time of the notification information (Step S23). Incidentally, the cell ID of the macrocell 21 is included in a synchronous signal transmitted from the MC base station 2. Therefore, the eICIC determining unit 14 acquires the cell ID of the macrocell 21 based on the synchronous signal received from the MC base station 2.

The processes at Steps S14 and S15 in FIG. 5 will be described in detail later.

Estimation of CRE Offset Value

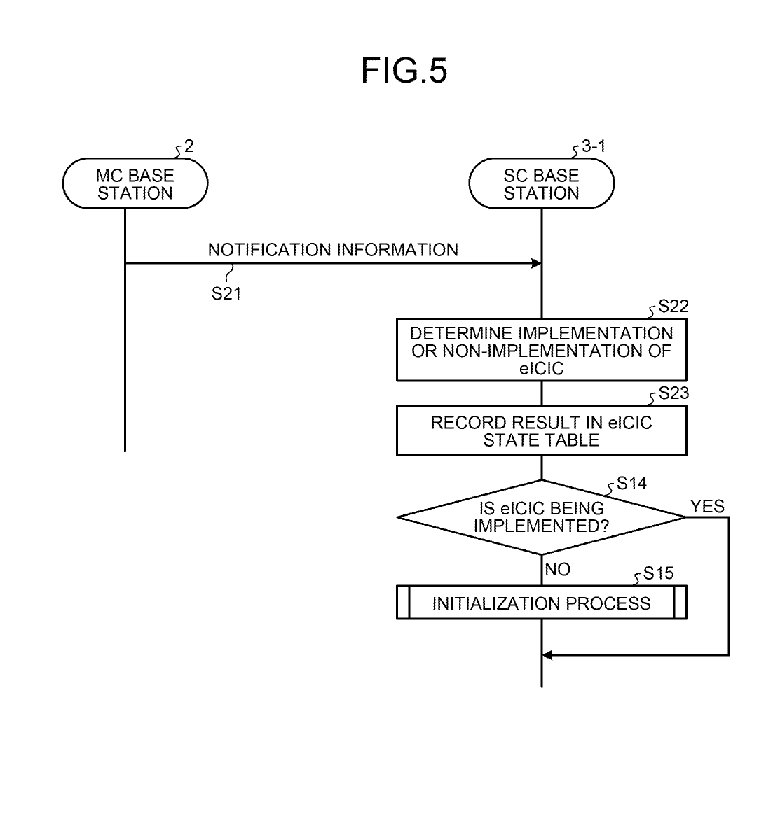

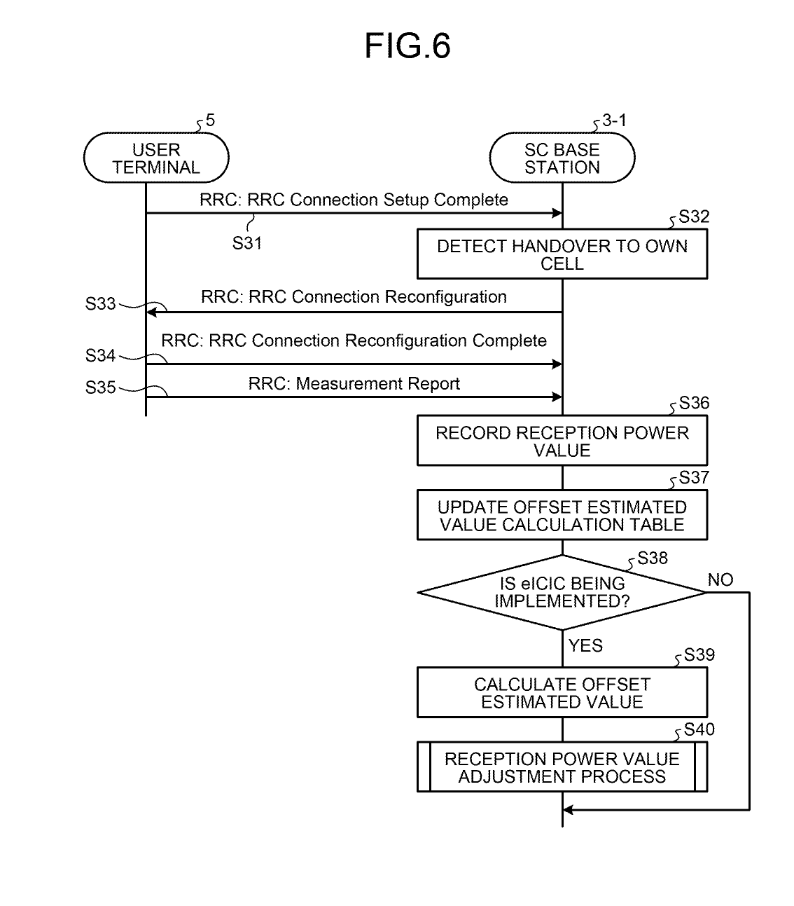

FIG. 6 is a diagram illustrating an example of the flow of a process performed by the communication system of the first embodiment.

In FIG. 6, the user terminal 5 transmits RRC: RRC Connection Setup Complete to the SC base station 3-1 upon performing a handover from the macrocell 21 to the small cell 31 (Step S31). In the SC base station 3-1 that has received RRC: RRC Connection Setup Complete, the communication control unit 15 detects the handover of the user terminal 5 to the small cell 31, that is, to the own cell, based on reception of RRC: RRC Connection Setup Complete (Step S32).

The communication control unit 15 that has detected the handover of the user terminal 5 instructs the user terminal 5 to notify the SC base station 3-1 of a downlink reception power value of the macrocell 21 and a downlink reception power value of the small cell 31 that is the own cell. The notification instruction is given by using RRC: RRC Connection Reconfiguration (Step S33).

The user terminal 5 that has received the notification instruction at Step S33 transmits RRC: RRC Connection Reconfiguration Complete to the SC base station 3-1 (Step S34). Further, the user terminal 5 measures the downlink reception power value of the macrocell 21 and the downlink reception power value of the small cell 31 in accordance with the notification instruction at Step S33, and notifies the SC base station 3-1 of results of the measurement. The results of the measurement of the downlink reception power values are notified by using RRC: RRC Measurement Report (Step S35).

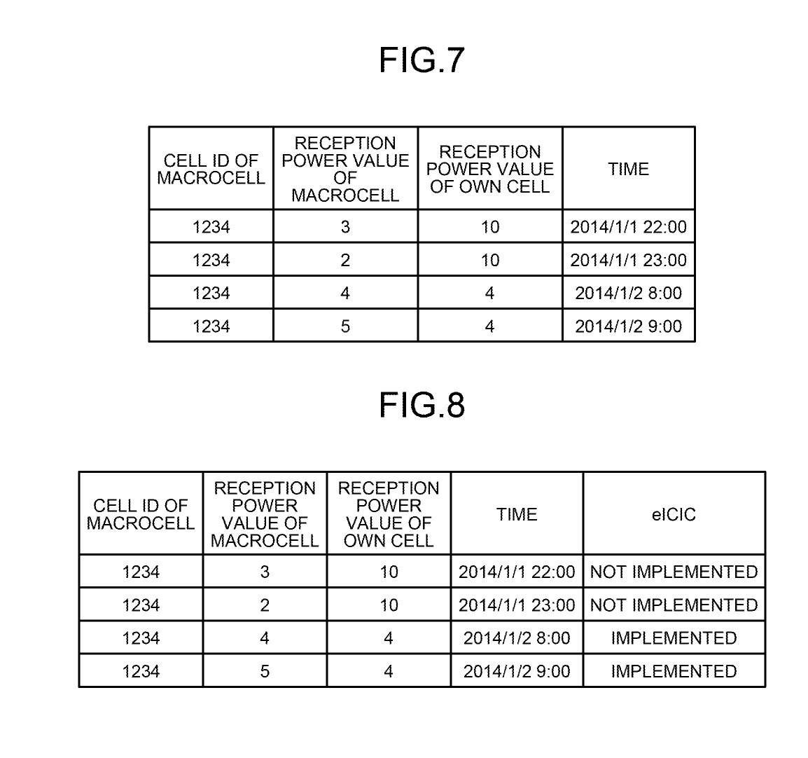

In the SC base station 3-1 that has received the results of the measurement of the downlink reception power values from the user terminal 5, the communication control unit 15 stores the downlink reception power value of the macrocell 21 and the downlink reception power value of the small cell 31 that is the own cell in the “reception power value table” in association with the cell ID of the macrocell 21 and a time of the handover of the user terminal 5 to the own cell (Step S36). The reception power value table is stored in the table storage unit 16. FIG. 7 is a diagram illustrating an example of the reception power value table of the first embodiment. Incidentally, the actual unit of the reception power value and the transmission power value is decibel-milliwatts (dBm). However, in the following, the reception power and the transmission power are described as values without units for simplicity of explanation. FIG. 7 indicates that, for example, the downlink reception power value of the macrocell 21 is “5” and the downlink reception power value of the small cell 31 that is the own cell is “4” on Jan. 2, 2014 at 9:00.

Subsequently, the communication control unit 15 integrates the eICIC state table (FIG. 3) and the reception power value table (FIG. 7) to update an “offset estimated value calculation table” (Step S37). The offset estimated value calculation table is stored in the table storage unit 16. By integrating the eICIC state table illustrated in FIG. 3 and the reception power value table illustrated in FIG. 7, the offset estimated value calculation table illustrated in FIG. 8 is obtained. In this case, the communication control unit 15 writes implementation or non-implementation of the eICIC in the offset estimated value calculation table as described below.

Specifically, the eICIC state table illustrated in FIG. 3 indicates that the eICIC is not implemented on Jan. 1, 2014 at 21:00 and the eICIC is implemented on Jan. 2, 2014 at 6:00. Therefore, the communication control unit 15 determines that the eICIC is not implemented from Jan. 1, 2014 at 21:00 to Jan. 2, 2014 at 5:59. Further, the communication control unit 15 determines that the eICIC is implemented from Jan. 2, 2014 at 6:00 to present. The communication control unit 15 writes whether the eICIC is implemented or not at the time of each handover in the offset estimated value calculation table based on a result of the determination. Therefore, in FIG. 8, for example, the eICIC is “not implemented” on Jan. 1, 2014 at 22:00 and on Jan. 1, 2014 at 23:00, and the eICIC is “implemented” on Jan. 2, 2014 at 8:00 and Jan. 2, 2014 at 9:00.

Subsequently, the communication control unit 15 refers to the latest record in the offset estimated value calculation table (FIG. 8), and checks the state of implementation of the eICIC at the time of the latest handover (Step S38). For example, in FIG. 8, the latest record is a record of Jan. 2, 2014 at 9:00, and the time of the latest handover is Jan. 2, 2014 at 9:00. Further, the eICIC is implemented on Jan. 2, 2014 at 9:00. If the eICIC is implemented at the time of the latest handover (YES at Step S38), the communication control unit 15 performs processes at Steps S39 and S40. In contrast, if the eICIC is not implemented at the time of the latest handover (NO at Step S38), the communication control unit 15 does not perform the processes at Steps S39 and S40.

In the offset estimated value calculation table (FIG. 8), the eICIC is implemented on Jan. 2, 2014 at 9:00, which is the time of the latest handover (YES at Step S38), the communication control unit 15 calculates the offset estimated value as described below (Step S39).

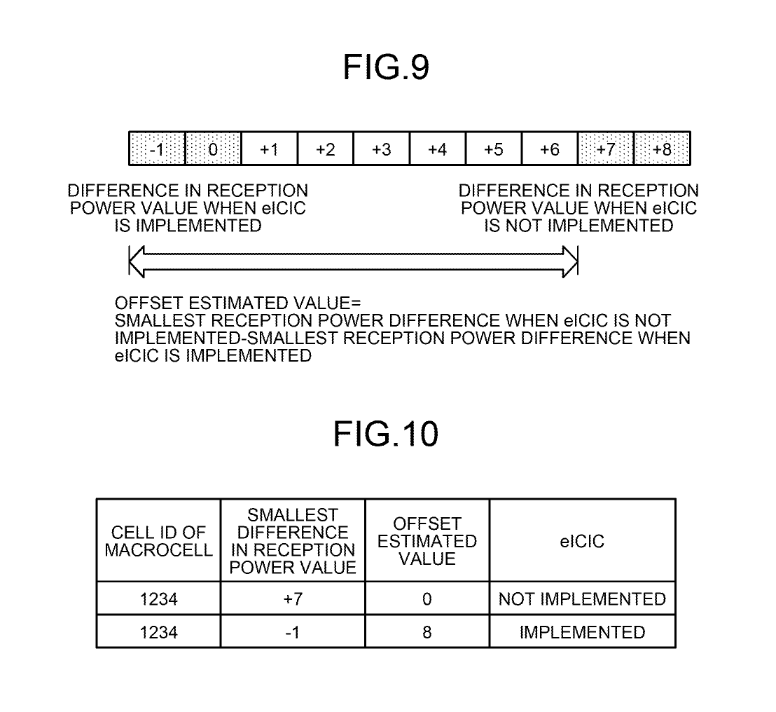

FIG. 9 is a diagram illustrating an example of an offset estimated value calculation method of the first embodiment.

The communication control unit 15 refers to the offset estimated value calculation table (FIG. 8), and calculates a difference between the downlink reception power value of the macrocell 21 and the downlink reception power value of the own cell (the small cell 31) based on each of the records corresponding to non-implementation of the eICIC. For example, the communication control unit 15 calculates “10−3=+7” as a downlink reception power difference at the time of non-implementation of the eICIC for the record of Jan. 1, 2014 at 22:00. Further, for example, the communication control unit 15 calculates “10−2=+8” as a downlink reception power difference at the time of non-implementation of the eICIC for the record of Jan. 1, 2014 at 23:00.

Furthermore, the communication control unit 15 calculates a difference between the downlink reception power value of the macrocell 21 and the downlink reception power value of the own cell (the small cell 31) for each of the records corresponding to implementation of the eICIC in the offset estimated value calculation table (FIG. 8). For example, the communication control unit 15 calculates “4−4=0” as a downlink reception power difference at the time of implementation of the eICIC for the record of Jan. 2, 2014 at 8:00. Further, for example, the communication control unit 15 calculates “4−5=−1” as a downlink reception power difference at the time of implementation of the eICIC for the record of Jan. 2, 2014 at 9:00.

Incidentally, each of the downlink reception power values is measured by the user terminal 5 in accordance with the notification instruction from the SC base station 3-1 at the time of the handover of the user terminal 5 to the small cell 31. The user terminal 5 measures the downlink reception power value of the macrocell 21 and the downlink reception power value of the small cell 31 immediately after the handover to the small cell 31 as described above. Further, as described above, according to the current 3GPP LTE specifications, the SC base station 3-1 does not take over the CRE offset value set by the MC base station 2. Therefore, the downlink reception power value of the own cell (the small cell 31) in the offset estimated value calculation table (FIG. 8) does not include the CRE offset value. Incidentally, according to the specifications, the CRE offset value is not taken over between the MC base stations 2.

Therefore, it is possible to estimate as follows, based on the downlink reception power differences “+7” and “+8” at the time of non-implementation of the eICIC calculated as described above. Specifically, it is possible to estimate that, while the eICIC is not implemented, the user terminal 5 performs a handover from the macrocell 21 to the small cell 31 when the reception power value of the small cell 31 is greater than the reception power value of the macrocell 21 by +7 to +8.

Furthermore, it is possible to estimate as follows, based on the downlink reception power differences “0” and “−1” at the time of implementation of the eICIC calculated as described above. Specifically, it is possible to estimate that, while the eICIC is implemented, the user terminal 5 performs a handover from the macrocell 21 to the small cell 31 when the reception power value of the small cell 31 is smaller than the reception power value of the macrocell 21 by 0 to 1.

Moreover, as described above, in the HetNet, the eICIC is implemented with the implementation of the CRE. Therefore, normally, when the eICIC is implemented, the CRE is also implemented.

Therefore, it is possible to estimate that the CRE offset value set in the small cell 31 by the MC base station 2 is a difference between “+7”, which is the smallest reception power difference at the time of non-implementation of the eICIC, and “−1”, which is the smallest reception power difference at the time of implementation of the eICIC, that is, “+7−(−1)=+8”.

Therefore, the communication control unit 15 calculates the CRE offset estimated value as “8”. That is, the communication control unit 15 estimates the CRE offset value set in the small cell 31 by the MC base station 2 based on the amount of change between the downlink reception power difference (+7, +8) at the time of non-implementation of the eICIC and the downlink reception power difference (−1, 0) at the time of implementation of the eICIC.

Further, as described above, it is possible to determine that the CRE is not implemented when the eICIC is not implemented. Therefore, the communication control unit 15 calculates the CRE offset estimated value corresponding to non-implementation of the eICIC as “0”.

Then, as illustrated in FIG. 10, the communication control unit 15 records the smallest reception power difference “+7” at the time of non-implementation of the eICIC, the CRE offset estimated value “0” at the time of non-implementation of the eICIC, the smallest reception power difference “−1” at the time of implementation of the eICIC, and the CRE offset estimated value “8” at the time of implementation of the eICIC in an “offset estimated value table” in association with the cell ID of the macrocell 21. FIG. 10 is a diagram illustrating an example of the offset estimated value table of the first embodiment. The offset estimated value table is stored in the table storage unit 16.

Incidentally, “the reception power value of the macrocell 21” of the user terminal 5 “at the time of implementation of the eICIC” is denoted by “M1”, and “the reception power value of the small cell 31” of the user terminal 5 “at the time of implementation of the eICIC” is denoted by “S1”. Further, “the downlink reception power value of the macrocell 21” of the user terminal 5 “at the time of non-implementation of the eICIC” is denoted by “M2”, and “the reception power value of the small cell 31” of the user terminal 5 “at the time of non-implementation of the eICIC” is denoted by “S2”. Therefore, a CRE offset estimated value “CRE_OFF 1” calculated by the communication control unit 15 is represented by Expression (1) with M1, S1, M2, and S2. Incidentally, “min” represents the minimum value.

CRE_OFF_1=min(S2−M2)−min(S1−M1) (1)

In Expression (1), “min(S2−M2)” corresponds to the smallest reception power difference between “the reception power value of the small cell 31” of the user terminal 5 “at the time of non-implementation of the eICIC” and “the downlink reception power value of the macrocell 21” of the user terminal 5 “at the time of non-implementation of the eICIC”. Further, in Expression (1), “min(S1−M1)” corresponds to the smallest reception power difference between “the reception power value of the small cell 31” of the user terminal 5 “at the time of implementation of the eICIC” and “the downlink reception power value of the macrocell 21” of the user terminal 5 “at the time of implementation of the eICIC”.

Incidentally, when “M1=M2” (for example, when the user terminal 5 has not moved), the communication control unit 15 may calculate a CRE offset estimated value “CRE_OFF_2” represented by Expression (2) below.

CRE_OFF_2=min(S2−S1) (2)

In Expression (2), “min(S2−S1)” corresponds to the smallest reception power difference between “the reception power value of the small cell 31” of the user terminal 5 “at the time of non-implementation of the eICIC” and “the reception power value of the small cell 31” of the user terminal 5 “at the time of implementation of the eICIC”.

Subsequent to the process at Step S39, the communication control unit 15 performs a reception power value adjustment process based on the CRE offset estimated value calculated at Step S39 (Step S40). The reception power value adjustment process is to adjust the downlink reception power value in the user terminal 5. As a process of adjusting the downlink reception power value in the user terminal 5, for example, three processes, which are first to third processes, as described below are applicable. As the first process, the downlink transmission power of the small cell 31 (that is, the own cell) is increased to increase the downlink reception power value of the small cell 31 in the user terminal 5. As the second process, a positive offset value is set for the downlink reception power value of the small cell 31 (that is, the own cell) to increase the downlink reception power value of the small cell 31 in the user terminal 5. As the third process, a negative offset value is set for the downlink reception power value of the macrocell 21 to decrease the downlink reception power value of the macrocell 21 in the user terminal 5.

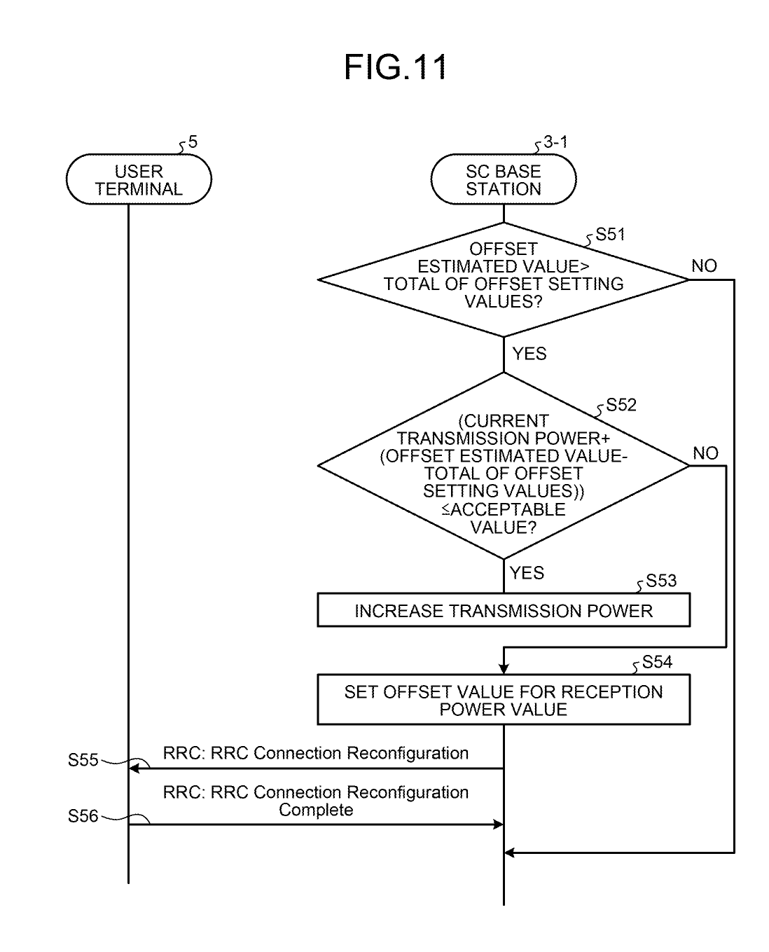

For example, the reception power value adjustment process at Step S40 is performed according to the flow of a process as illustrated in FIG. 11. FIG. 11 is a diagram illustrating an example of the flow of a process performed by the communication system of the first embodiment.

First, the communication control unit 15 determines whether the CRE offset estimated value calculated at Step S39 is greater than “a total of offset setting values” (Step S51). The total of the offset setting values is a total of absolute values of all of offset setting values set in an “offset setting value table”. FIG. 12 to FIG. 15 are diagrams illustrating an example of the offset setting value table of the first embodiment. The offset setting value table is stored in the table storage unit 16. FIG. 12 illustrates the offset setting value table in the initial state, that is, in which all of the offset setting values are set to “0”.

The CRE offset estimated value calculated at Step S39 as described above is “8”. Therefore, when the offset setting value table is in the state illustrated in FIG. 12, a result of the determination at Step S51 is “YES”, and the process proceeds to Step S52. Incidentally, if a result of the determination at Step S51 is “NO”, the communication control unit 15 does not perform the processes from Step S52 to Step S56.

At Step S52, the communication control unit 15 estimates whether a value obtained by adding the current downlink transmission power of the small cell 31 (that is, the own cell) and a difference between the CRE offset estimated value and the total of the offset setting values is equal to or smaller than an acceptable value of the downlink transmission power of the small cell 31. That is, the communication control unit 15 estimates whether the increased downlink transmission power of the small cell 31 becomes equal to or smaller than the acceptable value. For example, it is assumed that the current transmission power of the small cell 31 is an initial value of “10” and the acceptable value is “20”. Further, the CRE offset estimated value calculated at Step S39 as described above is “8”, and the total of the offset setting values when the offset setting value table is in the state illustrated in FIG. 12 is “0”. Therefore, “(10+(8−0))<20” is obtained at Step S51. Consequently, a result of the determination at Step S52 is “YES” and the process proceeds to Step S53.

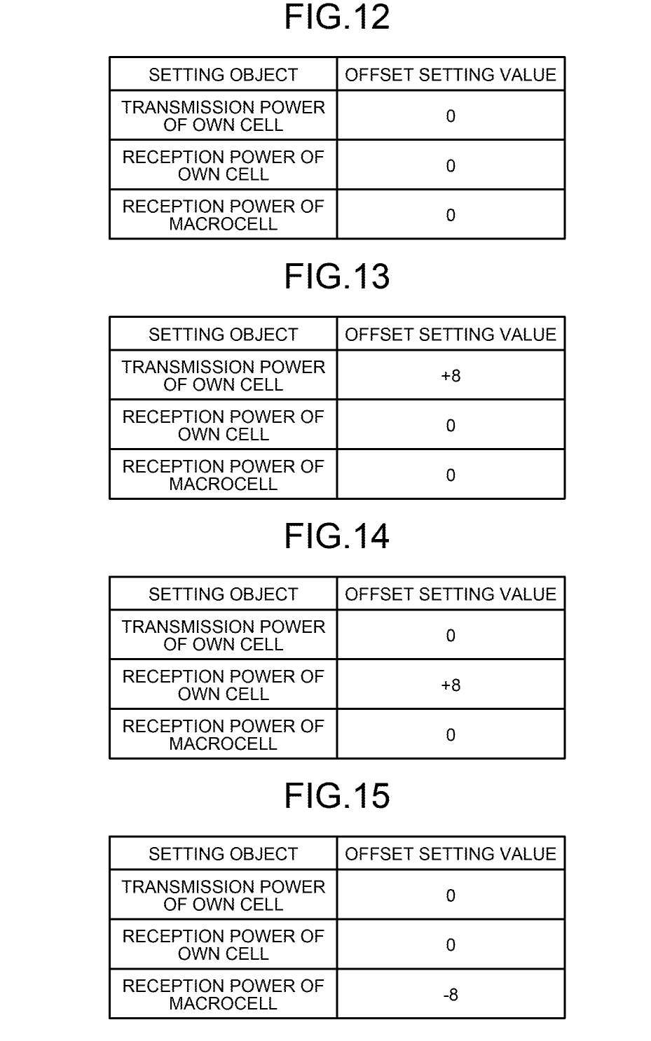

At Step S53, the communication control unit 15 increases the downlink transmission power of the small cell (that is, the own cell) as in the first process as described above. In this case, for example, the communication control unit 15 increases the downlink transmission power of the small cell 31 from the initial value by the CRE offset estimated value. That is, as illustrated in FIG. 13, the communication control unit 15 sets the offset value of “+8” for the downlink transmission power of the own cell in the offset setting value table. Therefore, the downlink transmission power of the small cell 31 is increased by “8” from the initial value of “10” resulting in “18”, so that the range of the small cell 31 is substantially expanded.

In this manner, in the first process, the downlink transmission power of the small cell 31 is increased by the amount corresponding to the CRE offset value, so that the downlink reception power value of the small cell 31 in the user terminal 5 is increased by the amount corresponding to the CRE offset value (Step S53). Therefore, even when the SC base station 3-1 is not configured to take over the CRE offset value set by the MC base station 2, in the user terminal 5 that has performed a handover from the macrocell 21 to the small cell 31 by the CRE, the level of the downlink reception power value of the small cell 31 can be maintained as the same level as it was before the handover. Consequently, the user terminal 5 that has just performed a handover can be prevented from performing a handover again from the small cell 31 to the macrocell 21. Further, with an increase in the downlink transmission power of the small cell 31, the range of the small cell 31 is substantially expanded. Therefore, it is possible to improve the reception quality of the user terminal 5 located near the cell edge of the small cell 31.

In contrast, when a result of the determination at Step S52 is “NO”, the communication control unit 15 sets an offset value for the reception power value as in the second process or the third process (Step S54). An operator of the communication system 1 can arbitrarily select whether to set a positive offset value for the downlink reception power value of the small cell 31 (that is, the own cell) as in the second process, or to set a negative offset value for the downlink reception power value of the macrocell 21 as in the third process.

For example, if the second process is performed, as illustrated in FIG. 14, the communication control unit 15 sets the offset value of “+8” for the downlink reception power value of the own cell in the offset setting value table (Step S54). Therefore, the downlink reception power value of the small cell 31 in the user terminal 5 is increased by “8”, so that the range of the small cell 31 is expanded in a pseudo manner.

In this manner, in the second process, the downlink reception power value of the small cell 31 in the user terminal 5 is increased by the amount corresponding to the CRE offset value. Therefore, even when the SC base station 3-1 is not configured to take over the CRE offset value set by the MC base station 2, in the user terminal 5 that has performed a handover from the macrocell 21 to the small cell 31 by the CRE, the level of the downlink reception power value of the small cell 31 can be maintained as the same level as it was before the handover. Consequently, the user terminal 5 that has just performed a handover can be prevented from performing a handover again from the small cell 31 to the macrocell 21.

For another example, if the third process is performed, as illustrated in FIG. 15, the communication control unit 15 sets the offset value of “−8” for the downlink reception power value of the macrocell 21 in the offset setting value table (Step S54). Therefore, the downlink reception power value of the macrocell 21 in the user terminal 5 is reduced by “8”.

In this manner, in the third process, the downlink reception power value of the macrocell 21 in the user terminal 5 is reduced by the amount corresponding to the CRE offset value. Therefore, even when the SC base station 3-1 is not configured to take over the CRE offset value set by the MC base station 2, in the user terminal 5 that has performed a handover from the macrocell 21 to the small cell 31 by CRE, the downlink reception power value of the macrocell 21 is reduced relative to the downlink reception power value before the handover so as to be smaller than the downlink reception power value of the small cell 31. Consequently, the user terminal 5 that has just performed a handover can be prevented from performing a handover again from the small cell 31 to the macrocell 21.

After the offset value is set at Step S54, the communication control unit 15 generates RRC: RRC Connection Reconfiguration including the offset setting value, and the SC base station 3-1 transmits RRC: RRC Connection Reconfiguration to the user terminal 5 (Step S55). Therefore, the offset value set by the communication control unit 15 is provided from the SC base station 3-1 to the user terminal 5. The user terminal 5 that has received RRC: RRC Connection Reconfiguration transmits RRC: RRC Connection Reconfiguration Complete to the SC base station 3-1 (Step S56).

As described above, in the first embodiment, the SC base station 3-1 forms the small cell 31 that is smaller than the macrocell 21 formed by the MC base station 2 and that overlaps with the macrocell 21. Further, the SC base station 3-1 includes the eICIC determining unit 14 and the communication control unit 15. The eICIC determining unit 14 determines the state of implementation of the eICIC between the macrocell 21 and the small cell 31 by the MC base station 2. The communication control unit 15 calculates a first downlink reception power difference between the macrocell 21 and the small cell 31 in the user terminal 5 at the time of non-implementation of the eICIC. Furthermore, the communication control unit 15 calculates a second downlink reception power difference between the macrocell 21 and the small cell 31 in the user terminal 5 at the time of implementation of the eICIC. Moreover, the communication control unit 15 estimates the CRE offset value set in the small cell 31 by the MC base station 2, based on the amount of change between the first downlink reception power difference and the second downlink reception power difference. Then, the communication control unit 15 adjusts the downlink reception power value in the user terminal 5 based on the estimated CRE offset value.

Therefore, it is possible to prevent the user terminal 5 that has just performed a handover from the macrocell 21 to the small cell 31 from performing a handover again from the small cell 31 to the macrocell 21. Consequently, it is possible to prevent frequent handovers.

Further, when estimating that the increased downlink transmission power of the small cell 31 becomes greater than the acceptable value, the communication control unit 15 sets a positive offset value for the downlink reception power value of the small cell 31 or sets a negative offset value for the downlink reception power value of the macrocell 21.

Therefore, it is possible to prevent frequent handovers while limiting the downlink transmission power of the small cell 31 to the acceptable value or smaller.

### [b] Second Embodiment

In a second embodiment, a process that follows the process in the first embodiment will be described. Specifically, an explanation is given of a process that is performed when a different user terminal 5 performs a handover to the small cell 31 while the reception power value table is in the state illustrated in FIG. 7.

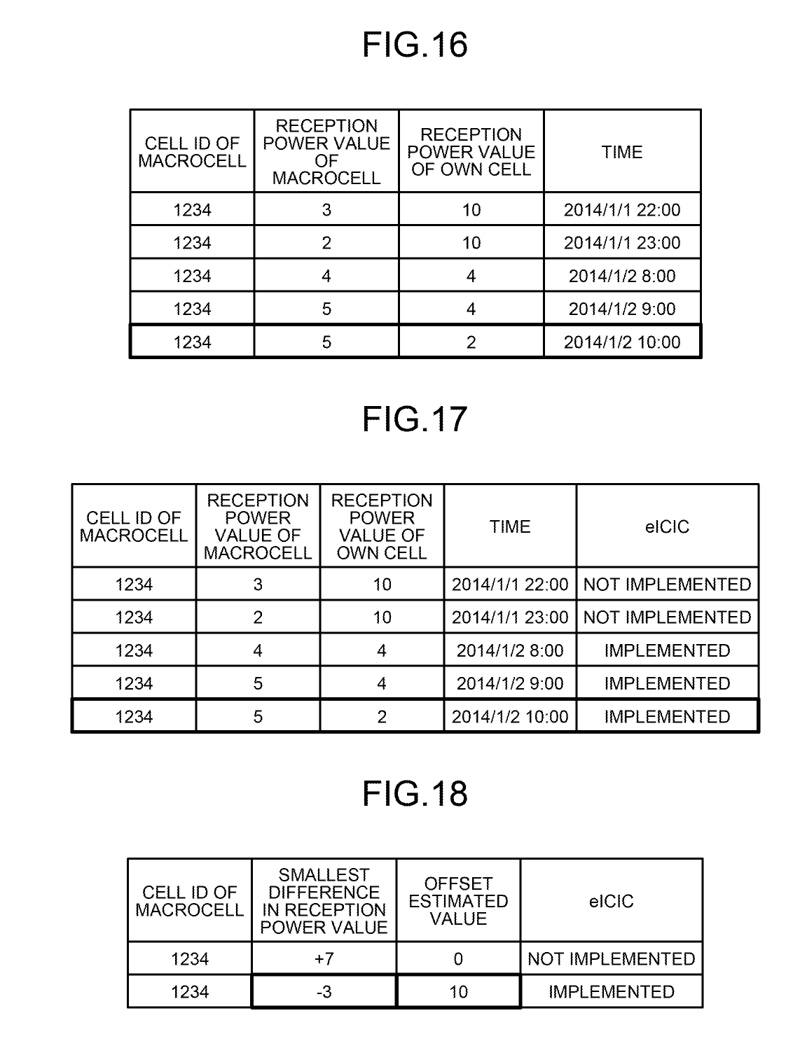

FIG. 16 is a diagram illustrating an example of the reception power value table of the second embodiment. FIG. 16 indicates that, as compared to FIG. 7, the downlink reception power value of the macrocell 21 is “5” and the downlink reception power value of the small cell 31 that is the own cell is changed to “2” on Jan. 2, 2014 at 10:00.

The communication control unit 15 integrates the eICIC state table (FIG. 3) and the reception power value table (FIG. 16) to update the offset estimated value calculation table. By integrating the eICIC state table illustrated in FIG. 3 and the reception power value table illustrated in FIG. 16, the offset estimated value calculation table is updated from FIG. 8 to FIG. 17. FIG. 17 is a diagram illustrating an example of the offset estimated value calculation table of the second embodiment.

Subsequently, the communication control unit 15 refers to the latest record in the offset estimated value calculation table (FIG. 17), and checks the state of implementation of the eICIC at the time of the latest handover. For example, in FIG. 17, the latest record is a record of Jan. 2, 2014 at 10:00, and the time of the latest handover is Jan. 2, 2014 at 10:00. Further, the eICIC is implemented on Jan. 2, 2014 at 10:00.

Therefore, the communication control unit 15 calculates the offset estimated value as described below. Specifically, in the offset estimated value calculation table in FIG. 17, the downlink reception power differences at the time of non-implementation of the eICIC are “+7” and “+8”. In contrast, the downlink reception power differences at the time of implementation of the eICIC are “0”, “−1”, and “−3”. Consequently, it is possible to estimate that the CRE offset value set in the small cell 31 by the MC base station 2 is a difference between the smallest reception power difference of “+7” at the time of non-implementation of the eICIC and the smallest reception power difference of “−3” at the time of implementation of the eICIC, that is, “+7−(−3)=+10”. Therefore, the communication control unit 15 calculates the CRE offset estimated value as “10”.

Then, the communication control unit 15 updates the offset estimated value table from FIG. 10 to FIG. 18. FIG. 18 is a diagram illustrating an example of the offset estimated value table of the second embodiment.

Subsequently, the communication control unit 15 refers to the offset setting value table illustrated in FIG. 13, and determines that the CRE offset estimated value of “10” is greater than the total “8” of the offset setting values.

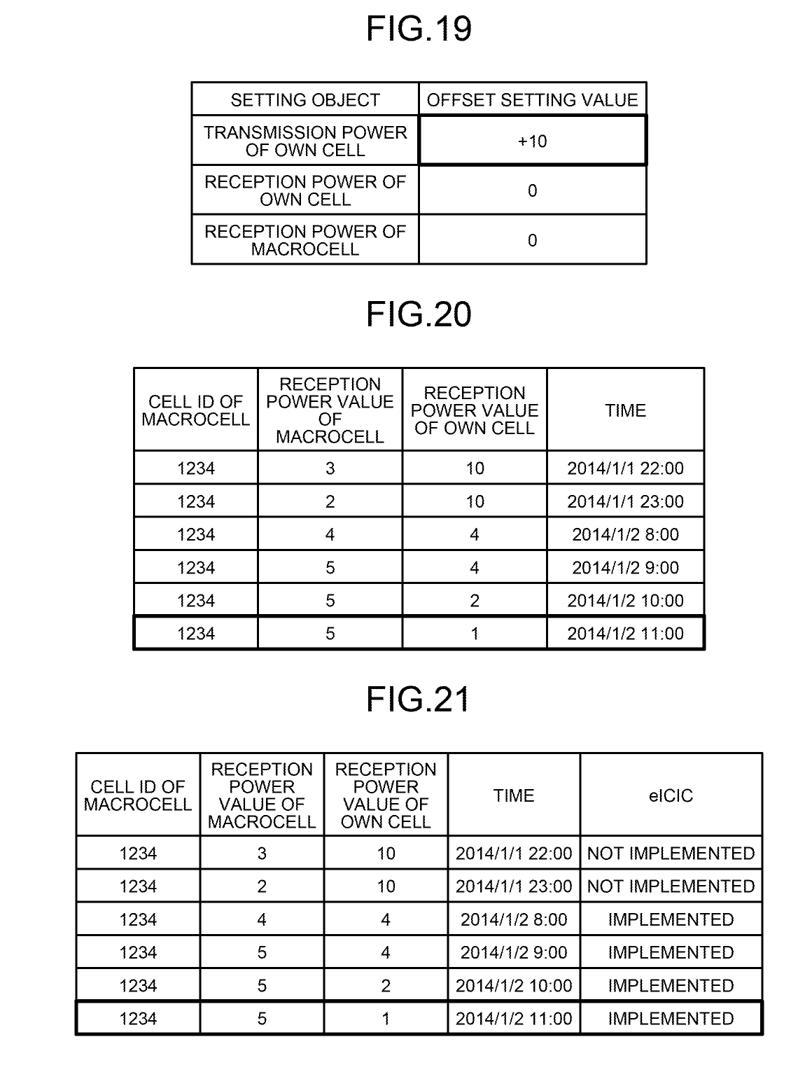

Furthermore, as a result of the process in the first embodiment, the current downlink transmission power of the small cell 31 is “18”. Moreover, the acceptable value is “20”. Therefore, a value obtained by adding a difference “2” between the CRE offset estimated value “10” and the total “8” of the offset setting values to the current downlink transmission power “18” of the small cell (that is, the own cell) is smaller than the acceptable value “20”. Therefore, the communication control unit 15 increases the downlink transmission power of the small cell 31 by the CRE offset estimated value “10” from the initial value “10”. Namely, as illustrated in FIG. 19, the communication control unit 15 sets the offset value “+10” for the downlink transmission power of the own cell in the offset setting value table to update the offset setting value table from FIG. 13 to FIG. 19. Consequently, the downlink transmission power of the small cell 31 is increased by “10” from the initial value “10” resulting in “20”. Therefore, the range of the small cell 31 is substantially expanded further from the state in the first embodiment.

### [c] Third Embodiment

In a third embodiment, a process that follows the process in the second embodiment will be described. Specifically, an explanation is given of a process that is performed when a different user terminal 5 performs a handover to the small cell 31 while the reception power value table is in the state illustrated in FIG. 16.

FIG. 20 is a diagram illustrating an example of the reception power value table of the third embodiment. FIG. 20 indicates that, as compared to FIG. 16, the downlink reception power value of the macrocell 21 is “5” and the downlink reception power value of the small cell 31 that is the own cell is changed to “1” on Jan. 2, 2014 at 11:00.

The communication control unit 15 integrates the eICIC state table (FIG. 3) and the reception power value table (FIG. 20) to update the offset estimated value calculation table. By integrating the eICIC state table illustrated in FIG. 3 and the reception power value table illustrated in FIG. 20, the offset estimated value calculation table is updated from FIG. 17 to FIG. 21. FIG. 21 is a diagram illustrating an example of the offset estimated value calculation table of the third embodiment.

Subsequently, the communication control unit 15 refers to the latest record in the offset estimated value calculation table (FIG. 21), and checks the state of implementation of the eICIC at the time of the latest handover. For example, in FIG. 20, the latest record is a record of Jan. 2, 2014 at 11:00, and the time of the latest handover is Jan. 2, 2014 at 11:00. Further, the eICIC is implemented on Jan. 2, 2014 at 11:00.

Therefore, the communication control unit 15 calculates the offset estimated value as described below. Specifically, in the offset estimated value calculation table in FIG. 21, the downlink reception power differences at the time of non-implementation of the eICIC are “+7” and “+8”. In contrast, the downlink reception power differences at the time of implementation of the eICIC are “0”, “−1”, “−3”, and “−4”. Consequently, it is possible to estimate that the CRE offset value set in the small cell 31 by the MC base station 2 is a difference between the smallest reception power difference of “+7” at the time of non-implementation of the eICIC and the smallest reception power difference of “−4” at the time of implementation of the eICIC, that is, “+7−(−4)=+11”. Therefore, the communication control unit 15 calculates the CRE offset estimated value as “11”.

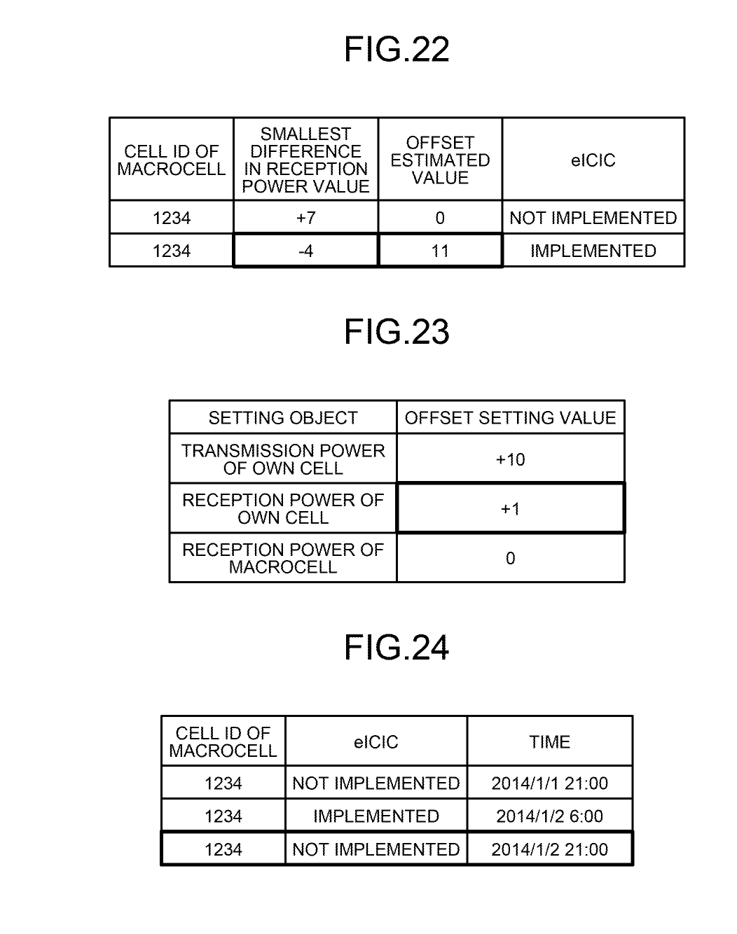

Then, the communication control unit 15 updates the offset estimated value table from FIG. 18 to FIG. 22. FIG. 22 is a diagram illustrating an example of the offset estimated value table of the third embodiment.

Subsequently, the communication control unit 15 refers to the offset setting value table illustrated in FIG. 19, and determines that the CRE offset estimated value of “11” is greater than the total “10” of the offset setting values.

Furthermore, as a result of the process in the second embodiment, the current downlink transmission power of the small cell 31 is “20”. Moreover, the acceptable value is “20”. Therefore, a value obtained by adding a difference “1” between the CRE offset estimated value “11” and the total “10” of the offset setting values to the current downlink transmission power “20” of the small cell (that is, the own cell) is greater than the acceptable value “20”. Therefore, the communication control unit 15 sets a positive offset value for the downlink reception power value of the small cell 31 (that is, the own cell). Because the offset of “+10” is already set for the downlink transmission power of the own cell, the communication control unit 15 sets the offset value of “11−10=+1” for the downlink reception power value of the own cell in the offset setting value table as illustrated in FIG. 23. Therefore, the offset setting value table is updated from FIG. 19 to FIG. 23.

Further, the communication control unit 15 generates RRC: RRC Connection Reconfiguration including “+1” as the offset setting value for the downlink reception power value of the own cell, and the SC base station 3-1 transmits RRC: RRC Connection Reconfiguration to the user terminal 5.

Therefore, the downlink transmission power of the small cell 31 is increased by “10” from the initial value “10” resulting in “20”. Consequently, the range of the small cell 31 is substantially expanded. Further, the downlink reception power value of the small cell 31 in the user terminal 5 is increased by “1”, and the range of the small cell 31 is further expanded in a pseudo manner.

As described above, in the second embodiment and the third embodiment, the communication control unit 15 calculates the offset estimated value every time the user terminal 5 performs a handover to the small cell 31.

Therefore, it is possible to calculate the offset estimated value based on the latest downlink reception power value, enabling to improve the estimation accuracy of the offset estimated value.

### [d] Fourth Embodiment

In a fourth embodiment, a process that follows the process in the third embodiment will be described. Specifically, an explanation is given of a process performed when the state of implementation of the eICIC is changed from FIG. 3.

FIG. 24 is a diagram illustrating an example of the eICIC state table of the fourth embodiment. FIG. 24 illustrates a state in which the eICIC between the macrocell 21 and the small cell 31 is changed to the state of non-implementation on Jan. 2, 2014 at 21:00, as compared to FIG. 3. Therefore, a result of the determination at Step S14 in FIG. 4 and FIG. 5 is “NO”, and the process proceeds to Step S15 to perform the “initialization process”. Incidentally, if the state of implementation of the eICIC in the latest record in the eICIC state table is “implemented”, a result of the determination at Step S14 in FIG. 4 and FIG. 5 is “YES”, and the initialization process at Step S15 is not performed.

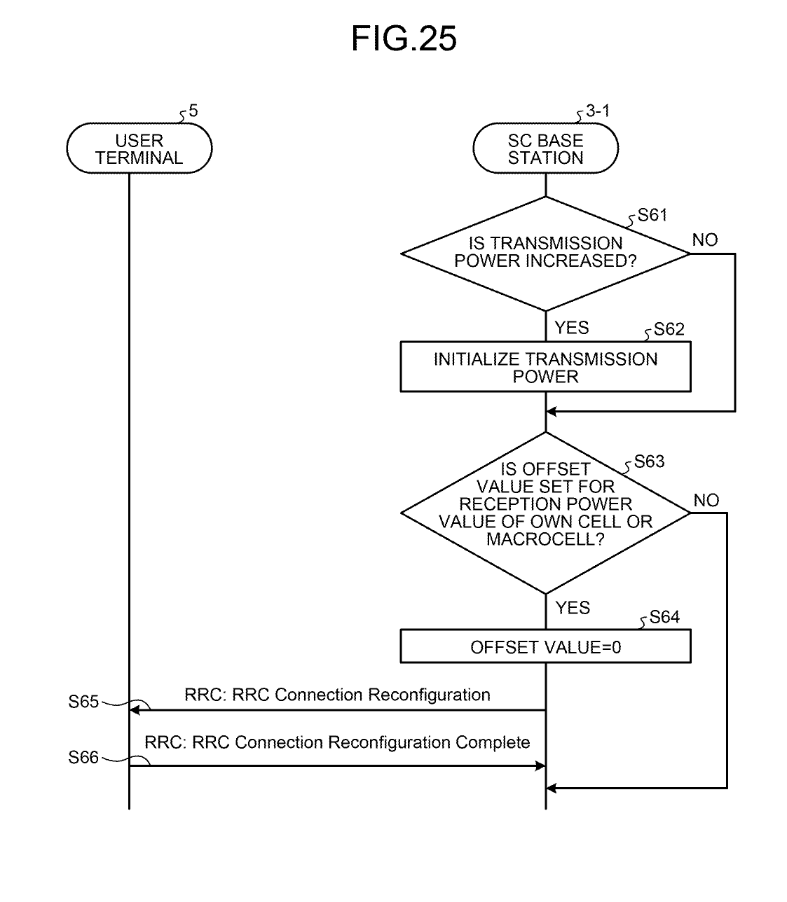

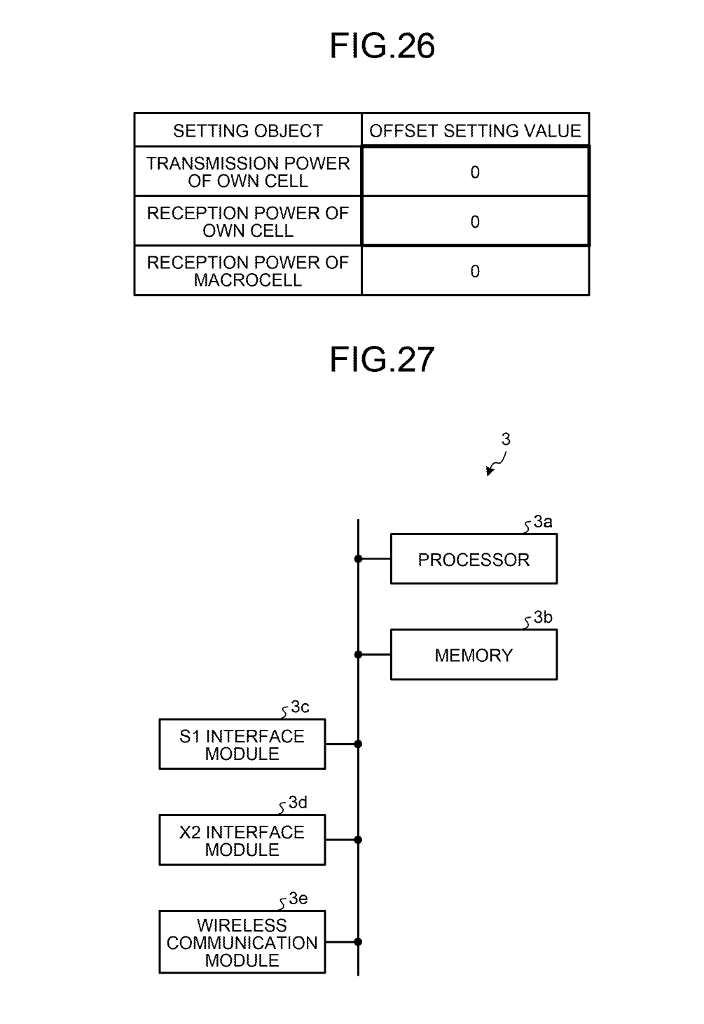

The initialization process will be described below with reference to FIG. 25 and FIG. 26. FIG. 25 is a diagram illustrating an example of the flow of a process performed by the communication system of the fourth embodiment. FIG. 26 is a diagram illustrating an example of the offset setting value table of the fourth embodiment.

At Step S61 in FIG. 25, the communication control unit 15 refers to the offset setting value table, and determines whether the downlink transmission power of the small cell 31 is increased from the initial value (Step S61). The updated offset setting value table in the third embodiment is illustrated in FIG. 23; therefore, in this example, a result of the determination at Step S61 is “YES”. Therefore, to return the downlink transmission power of the small cell 31 to the initial value, as illustrated in FIG. 26, the communication control unit 15 sets the offset value for the downlink transmission power of the own cell to “0” in the offset setting value table (Step S62). Therefore, the downlink transmission power of the small cell 31 is initialized to the initial value “10”.

Incidentally, if a result of the determination at Step S61 is “NO”, the process at Step S62 is not performed.

Subsequently, the communication control unit 15 refers to the offset setting value table, and determines whether the offset value is set for the downlink reception power value of the small cell 31 (that is, the own cell) or the macrocell 21 (Step S63). The updated offset setting value table in the third embodiment is illustrated in FIG. 23; therefore, a result of the determination at Step S63 is “YES”. Therefore, as illustrated in FIG. 26, the communication control unit 15 sets the offset values to “0” for the downlink reception power values of the own cell and the macrocell 21 in the offset setting value table (Step S64).

Through the processes at Step S62 and Step S64, all of the offset setting values in the offset setting value table are initialized to “0”, and the offset setting value table is updated from FIG. 23 to FIG. 26. Further, because all of the offset setting values are initialized to “0” in the offset setting value table, the communication control unit 15 does not adjust the downlink reception power value in the user terminal 5.

After the process at Step S64, the communication control unit 15 generates RRC: RRC Connection Reconfiguration including “0” as the offset setting values for the downlink reception power values of the own cell and the macrocell 21, and the SC base station 3-1 transmits RRC: RRC Connection Reconfiguration to the user terminal 5 (Step S65). The user terminal 5 that has received RRC: RRC Connection Reconfiguration transmits RRC: RRC Connection Reconfiguration Complete to the SC base station 3-1 (Step S66).

Incidentally, if a result of the determination at Step S63 is “NO”, the processes from Steps S64 to S66 are not performed.

As described above, in the fourth embodiment, when the eICIC is not performed, the communication control unit 15 does not adjust the downlink reception power value in the user terminal 5.

Therefore, it is possible to accurately control a handover when the MC base station 2 has not set the CRE offset value in the small cell 31.

### [e] Other Embodiments

[1] The communication control unit 15 may calculate an offset estimated value “CRE_OFF_3” represented by Expression (3), instead of the offset estimated value “CRE_OFF_1” represented by Expression (1).

CRE_OFF_3=min(S2−S1)−min(M2−M1) (3)

In Expression (3), “min(M2−M1)” corresponds to the smallest reception power difference between “the downlink reception power value of the macrocell 21” of the user terminal 5 “at the time of non-implementation of the eICIC” and “the downlink reception power value of the macrocell 21” of the user terminal 5 “at the time of implementation of the eICIC”.

[2] In the first embodiment, an example has been described in which only the macrocell 21 serves as a macrocell that overlaps with the small cell 31. However, in some cases, a plurality of macrocells may overlap with the small cell 31. In this case, the communication control unit 15 estimates the CRE offset value for each of the macrocells, and selects, as the offset setting value, the largest value from among the estimated CRE offset values.

[3] When a value obtained by adding a difference between the CRE offset estimated value and the total of the offset setting values to the current downlink transmission power of the small cell 31 is greater than the acceptable value of the small cell 31, the offset value may be set as described below. Specifically, in this case, the downlink transmission power is first increased to the acceptable value, and a value obtained by subtracting the increase from the CRE offset estimated value may be set as the offset value for the downlink reception power value of the small cell 31 or the macrocell 21.

[4] The SC base station 3 is realized by a hardware configuration as described below. FIG. 27 is a diagram illustrating a hardware configuration example of the small cell base station (SC base station). As illustrated in FIG. 27, the SC base station 3 includes, as hardware components, a processor 3a, a memory 3b, an S1 interface module 3c, an X2 interface module 3d, and a wireless communication module 3e. Examples of the processor 3a include a central processing unit (CPU), a digital signal processor (DSP), and a field programmable gate array (FPGA). The SC base station 3 may include a large scale integrated circuit (LSI) including the processor 3a and peripheral circuits. Examples of the memory 3b include a random access memory (RAM), such as a synchronous dynamic random access memory (SDRAM), a read only memory (ROM), and a flash memory.

The antenna 11 and the wireless communication unit 12 are realized by the wireless communication module 3e. The S1 communication unit 18 is realized by the S1 interface module 3c. The X2 communication unit 17 is realized by the X2 interface module 3d. The table storage unit 16 is realized by the memory 3b. The BB processing unit 13, the eICIC determining unit 14, and the communication control unit 15 are realized by the processor 3a.

According to an embodiment of the disclosed technology, it is possible to prevent frequent handovers.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A base station that forms a second cell that overlaps with a first cell formed by a different base station, the base station comprising:
a determining unit that determines a state of implementation of inter-cell interference coordination that is performed between the first cell and the second cell by the different base station; and
a control unit that estimates an offset value set by the different base station for a downlink reception power value of the second cell, based on first reception power of the second cell in a user terminal at the time of non-implementation of the inter-cell interference coordination and based on second reception power of the second cell in the user terminal at the time of implementation of the inter-cell interference coordination, and adjusts the downlink reception power value in the user terminal based on the estimated offset value.

2. The base station according to claim 1, wherein the control unit calculates a first downlink reception power difference between a third reception power of the first cell in the user terminal at the time of non-implementation of the inter-cell interference coordination and the first reception power, calculates a second downlink reception power difference between a fourth reception power of the first cell in the user terminal at the time of implementation of the inter-cell interference coordination and the second reception power, and estimates the offset value based on an amount of change between the first downlink reception power difference and the second downlink reception power difference.

3. The base station according to claim 1, wherein the control unit calculates a first downlink reception power difference between the first reception power and the second reception power, calculates a second downlink reception power difference between a third reception power of the first cell in the user terminal at the time of non-implementation of the inter-cell interference coordination and a fourth reception power of the first cell in the user terminal at the time of implementation of the inter-cell interference coordination, and estimates the offset value based on an amount of change between the first downlink reception power difference and the second downlink reception power difference.

4. The base station according to claim 1, wherein the control unit increases downlink transmission power of the second cell to increase the downlink reception power value of the second cell in the user terminal.

5. The base station according to claim 1, wherein the control unit sets a positive value of the offset value for the downlink reception power value of the second cell to increase the downlink reception power value of the second cell in the user terminal.

6. The base station according to claim 5, wherein the control unit sets the positive value when estimating that an increased downlink transmission power of the second cell exceeds an acceptable value.

7. The base station according to claim 1, wherein the control unit sets a negative value of the offset value for a downlink reception power value of the first cell to reduce the downlink reception power value of the first cell in the user terminal.

8. The base station according to claim 7, wherein the control unit sets the negative value when estimating that an increased downlink transmission power of the second cell exceeds an acceptable value.

9. The base station according to claim 1, wherein the control unit estimates the offset value every time the user terminal performs a handover to the second cell.

10. The base station according to claim 1, wherein when the inter-cell interference coordination is not implemented, the control unit does not adjust the downlink reception power value in the user terminal.

11. A communication control method implemented by a base station that forms a second cell that overlaps with a first cell formed by a different base station, the communication control method comprising:
determining a state of implementation of inter-cell interference coordination that is performed between the first cell and the second cell by the different base station;
estimating an offset value set by the different base station for a downlink reception power value of the second cell, based on first reception power of the second cell in a user terminal at the time of non-implementation of the inter-cell interference coordination and based on second reception power of the second cell in the user terminal at the time of implementation of the inter-cell interference coordination; and
adjusting the downlink reception power value in the user terminal based on the estimated offset value.
